(19) United States
(12) Patent Application Publication
(10) Pub. No.: US 2022/0053102 A1
(43) Pub. Date: Feb. 17, 2022

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Yoshihide KOTANI, Kanagawa (JP)

(73) Assignee: FUJIFILM BUSINESS INNOVATION CORP., Tokyo (JP)

(21) Appl. No.: 17/179,582

(22) Filed: Feb. 19, 2021

(30) Foreign Application Priority Data
Aug. 13, 2020 (JP) 2020-136724

(51) Int. Cl. H04N 1/00

(52) U.S. Cl. CPC H04N 1/00514; H04N 2201/0094; H04N 1/00344

(57) ABSTRACT

An information processing apparatus includes a processor configured to obtain information regarding past usage of a device managed by a manager from stored information, the stored information storing information regarding the past usage of a device in connection with identification information of the device, extract, of obtained information regarding the past usage, information on an item predetermined according to a role that the manager has, and send extracted information to a terminal of the manager.

### CROSS-REFERENCE TO RELATED APPLICATIONS

This application is based on and claims priority under 35 USC 119 from Japanese Patent Application No. 2020-136724 filed Aug. 13, 2020.

### BACKGROUND

### (i) Technical Field

The present disclosure relates to an information processing apparatus and a non-transitory computer readable medium.

### (ii) Related Art

In recent years, there are proposed information output apparatuses, in each of which output contents of various reports regarding the information output apparatus are generated differently for different users (for example, see Japanese Unexamined Patent Application Publication No. 2015-46751).

The information output apparatus described in Japanese Unexamined Patent Application Publication No. 2015-46751 is an information output apparatus that outputs various report pages regarding the information output apparatus in response to a command of a user after the user logged in and includes a user determination part and a report output part. The user determination part determines, at the time of outputting a report page, whether the user who is currently logging in this apparatus is a specific user or a general user, and the report output part outputs a report page based on less confidential general information when the user is the general user and outputs a report page based on the general information and highly confidential specific information when the user is the specific user.

### SUMMARY

Aspects of non-limiting embodiments of the present disclosure relate to an information processing apparatus that provides, for multiple managers who manage different items of devices, information on an item associated with a role of a manager and to a non-transitory computer readable medium storing a program therefor.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing apparatus including a processor configured to obtain information regarding past usage of a device managed by a manager from stored information, the stored information storing information regarding the past usage of a device in connection with identification information of the device, extract, of obtained information regarding the past usage, information on an item predetermined according to a role that the manager has, and send extracted information to a terminal of the manager.

### BRIEF DESCRIPTION OF THE DRAWINGS

An exemplary embodiment of the present disclosure will be described in detail based on the following figures, wherein:

FIG. 1 is a diagram illustrating an example of schematic configuration of an information processing system according to an exemplary embodiment of the present disclosure;

FIG. 2 is a block diagram illustrating an example of control system of a server;

FIG. 3 is a diagram illustrating an example of a user information table;

FIG. 4 is a diagram illustrating an example of a business office information table;

FIG. 5 is a diagram illustrating an example of a device contract information table;

FIG. 6 is a diagram illustrating an example of a role master information table;

FIG. 7 is a diagram illustrating an example of a machine master information table;

FIG. 8 is a diagram illustrating an example of a machine information table;

FIG. 9 is a diagram illustrating an example of an acquisition screen;

FIG. 10 is a diagram illustrating an example of a selection screen; and

FIG. 11 is a flowchart illustrating an example of operation of the server.

### DETAILED DESCRIPTION

An exemplary embodiment of the present disclosure will be described below with reference to drawings. Note that same reference numerals designate constituent elements having substantially same functions across the drawings, and overlapping descriptions thereof are omitted.

### Summary of Exemplary Embodiment

An information processing apparatus according to the exemplary embodiment includes a processor configured to obtain information regarding past usage of a device managed by a manager from stored information, the stored information storing information regarding the past usage of a device in connection with identification information of the device, extract, of obtained information regarding the past usage, information on an item predetermined according to a role that the manager has, and send extracted information to a terminal of the manager.

The role is a task or authority assigned to or selected for a manager in relation to devices. The role is, for example, management of the devices themselves as facility, management of security when operating the devices, management of consumables of the devices, or the like. The item is, for example, the number of printed pages, the used amount of toner or the like, FAX communication records, pay-per-use charges, or the like. The past usage is a record obtained by tabulating daily usage.

### Exemplary Embodiment

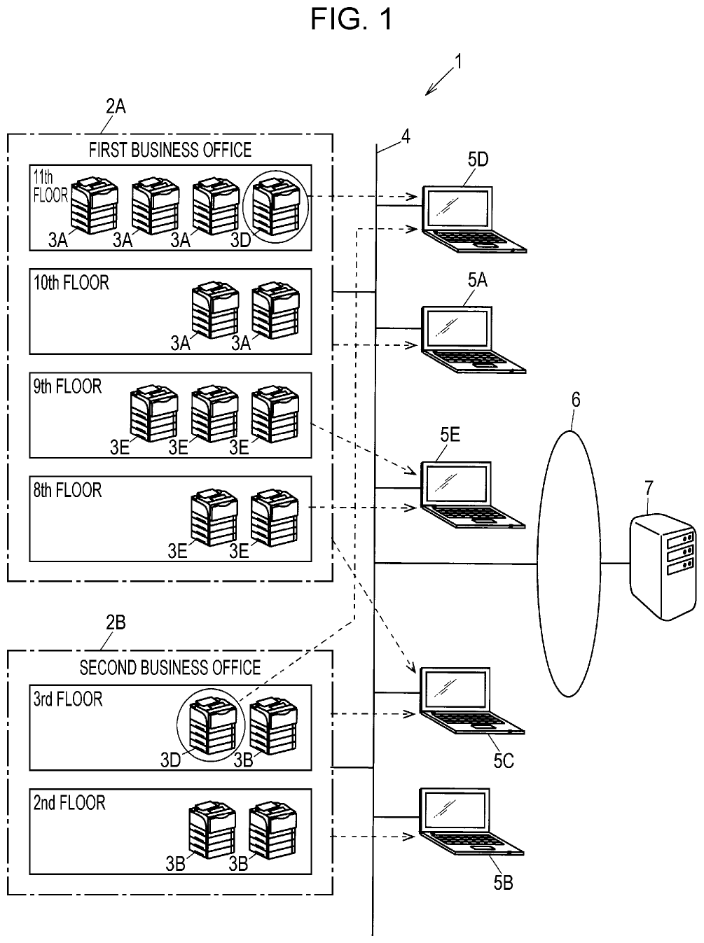

FIG. 1 is a diagram illustrating an example of schematic configuration of an information processing system according to the exemplary embodiment of the present disclosure. This information processing system 1 includes multiple devices 3A to 3E (hereinafter, referred to as “device 3” or “devices 3” when collectively referred to) installed in a first business office 2A and a second business office 2B, facility manager terminals 5A and 5B, a general manager terminal 5C, a security manager terminal 5D, and an accounting manager terminal 5E (hereinafter, referred to as “manager terminal 5” or “manager terminals 5” when collectively referred to) that are connected to the multiple devices 3 via an internal network 4, and a server 7 that is connected to the multiple devices 3 and the multiple manager terminals 5 via an external network 6 and sends to the manager terminals 5 information regarding the devices 3. The information regarding the devices 3 is, for example, of information regarding past usage of the devices 3, information associated with the role of a manager who uses the manager terminal 5. The server 7 is an example of the information processing apparatus.

Note that the number of business offices in which the devices 3 are installed may be one, or three or more. The place in which the device 3 is installed is not limited to a business office and may alternatively be facility or a place such as a school, a hospital, a share office, a convenient store, or the like. The manager terminal 5 is not limited to the above.

The internal network 4 is, for example, a local area network (LAN), a wide area network (WAN), an intranet, or the like, and may be a wired or wireless network. The external network 6 is, for example, the Internet or the like and may be a wired or wireless network.

### Device Configuration

The device 3 is, for example, a multifunction machine having a scan function, a print function, a copy function, an e-mail function, a facsimile sending and receiving function (hereinafter, may be referred to as “FAX function”), and the like. The multifunction machine is an example of an image forming apparatus.

Note that the device 3 may be an image forming apparatus such as a printer, a facsimile, or the like. The device 3 is not limited to the image forming apparatus and may alternatively be an information processing apparatus such as a multifunction mobile phone (smartphone), a personal computer (PC), a tablet terminal, or the like. Furthermore, all or part of the multiple devices 3 may be an image forming apparatus.

In the case illustrated in FIG. 1, the devices 3E are installed on the 8th floor and the 9th floor, the devices 3A are installed on the 10th floor, and the devices 3A and the device 3D are installed on the 11th floor of the first business office 2A. The devices 3B are installed on the 2nd floor, and the devices 3B and 3D are installed on the 3rd floor of the second business office 2B. The devices 3A to 3D include devices of different models and devices having different functions. For example, while the device 3D has the FAX function, the other devices 3A, 3B, 3C, and 3E do not have the FAX function.

The device 3 regularly (for example, 18:00 every day) sends information regarding the device 3, for example, usage information with the model name and the machine number to the server 7 via the internal network 4 and the external network 6.

### Manager Terminal Configuration

The manager terminal 5 is an information processing terminal such as a personal computer (PC) or the like. Note that the manager terminal 5 may alternatively be a notebook personal computer, a mobile information processing terminal such as a tablet terminal or the like, or a mobile communication terminal such as a multifunction mobile phone (smartphone) or the like.

The facility manager terminal 5A is a terminal used by a facility manager of the first business office 2A. For example, this facility manager has the role whose role name is Facility and manages all the devices 3A, 3D, and 3E installed in the first business office 2A. The facility manager terminal 5B is a terminal used by a facility manager of the second business office 2B. For example, this facility manager has the role whose role name is Facility and manages all the devices 3B and 3D installed in the second business office 2B. The general manager terminal 5C is a terminal used by a general manager who manages all the business offices 2A and 2B. For example, the general manager has the role whose role name is Facility and manages all the devices 3 installed in all the business offices 2A and 2B.

The security manager terminal 5D is a terminal used by a security manager. For example, the security manager has the role whose role name is Audit and manages FAX communication records of the devices 3D having the FAX function and being installed on the 11th floor of the first business office 2A and the 3rd floor of the second business office 2B. The accounting manager terminal 5E is a terminal used by an accounting manager. For example, the accounting manager is an accounting manager of an organization X, has the role whose role name is Accounting, and manages an item regarding a pay-per-use charge of the device 3E that belongs to the organization X and another similar item.

### Server Configuration

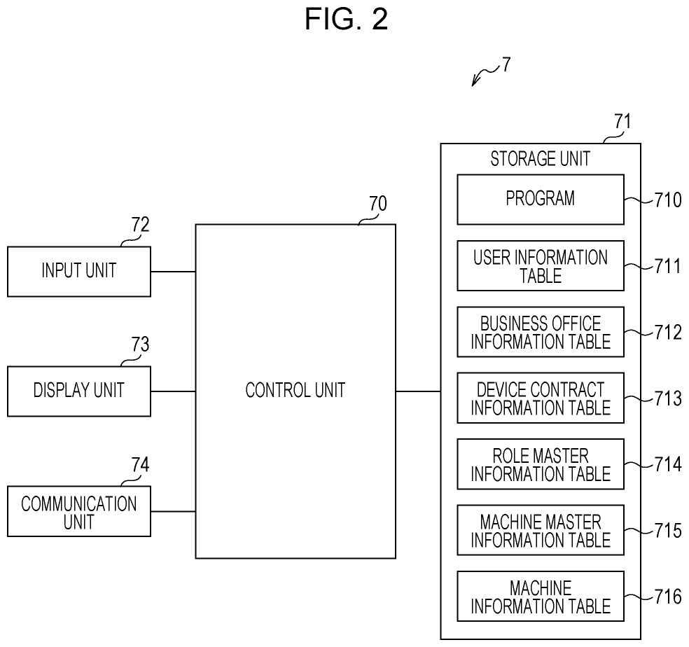

FIG. 2 is a block diagram illustrating an example of control system of the server 7. The server 7 includes a control unit 70 that controls each unit of the server 7, and this control unit 70 is connected to a storage unit 71, an input unit 72 realized by a keyboard, a mouse, and the like, a display unit 73 realized by a liquid crystal display and the like, and a communication unit 74 that communicates with the devices 3, the manager terminals 5, and the like via the external network 6.

The control unit 70 includes a processor such as a central processing unit (CPU) or the like, an interface, and the like. The control unit 70 collects information from the devices 3, stores collected information, sends information to the manager terminals 5, and the like, by executing a program 710 stored in the storage unit 71.

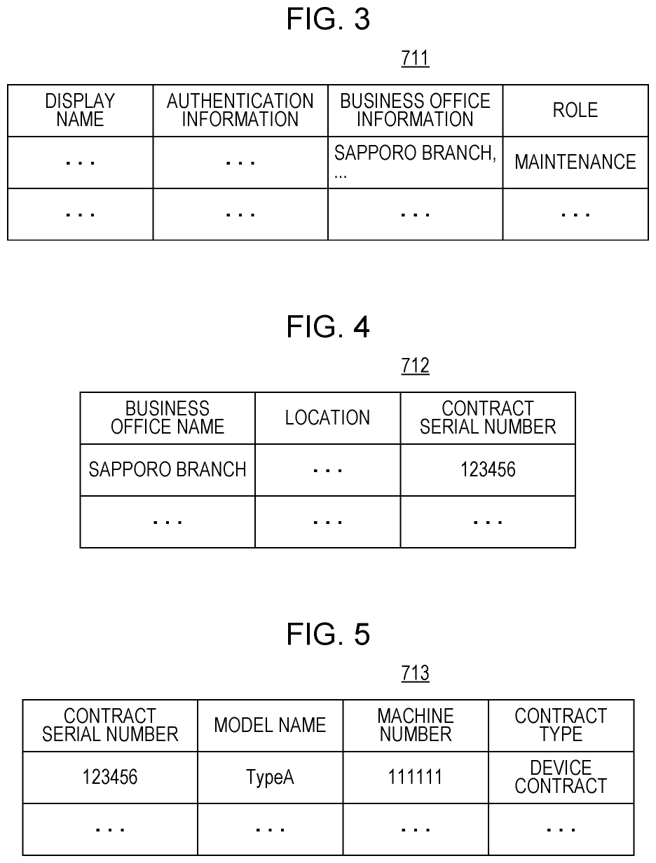

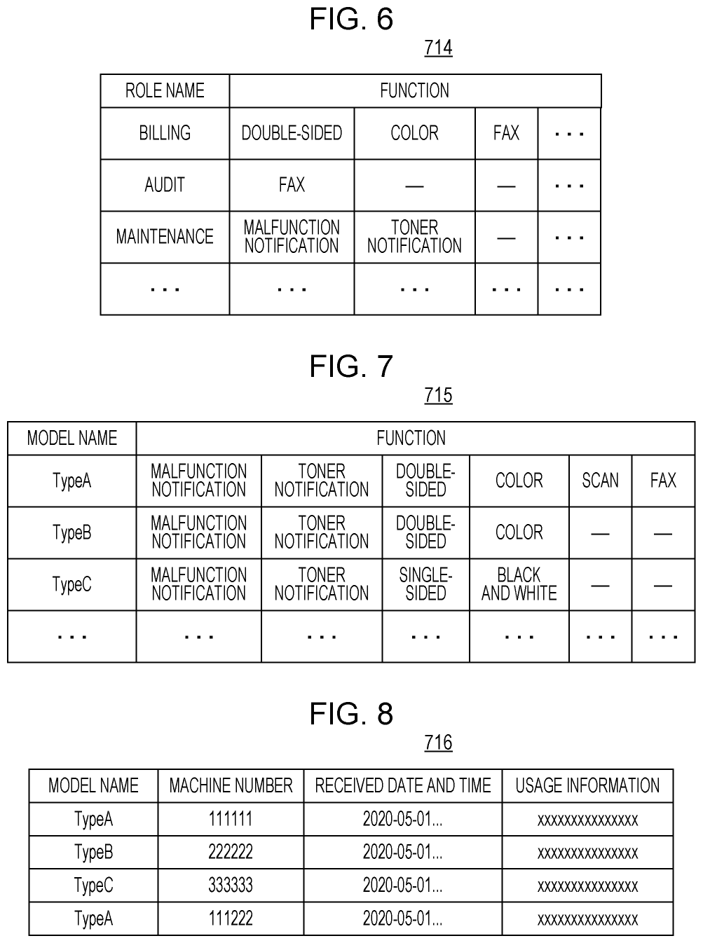

The storage unit 71 includes a read only memory (ROM), a random access memory (RAM), a hard disk, or the like, and stores therein a variety of information such as the program 710, a user information table 711 (see FIG. 3), a business office information table 712 (see FIG. 4), a device contract information table 713 (see FIG. 5), a role master information table 714 (see FIG. 6), a machine master information table 715 (see FIG. 7), a machine information table 716 (see FIG. 8), and the like. Each of the tables 711 to 716 is an example of the stored information.

FIG. 3 is a diagram illustrating an example of the user information table 711. The user information table 711 includes multiple items such as “Display name”, “Authentication information”, “Business office information”, “Role”, and the like. User information made up of these items is recorded by the control unit 70 at the time of registration of a manager. In the “Display name”, a username of the manager is recorded. In the “Authentication information”, a user ID, a password, and the like, which are needed for logging in, are recorded. In the “Business office information”, one or more business office names, one or more locations of the one or more business offices, and the like are recorded as a collective entity of the one or more business offices managed by the user. The business office name may be a business office number, a business office reference code, or the like, assigned to a business office. In some cases, the user manages multiple business offices. Since the business office is a place where a device is installed, the user information includes information on a place where the device 3 managed by a manager is installed. In the “Role”, a role that the user has is recorded. The authentication information is an example of the identification information of the manager. The user information is an example of information regarding the manager.

FIG. 4 is a diagram illustrating an example of the business office information table 712. The business office information table 712 includes multiple items such as “Business office name”, “Location”, “Contract serial number”, and the like. Business office information made up of these items is recorded by the control unit 70 at the time of conclusion of a contract or the like. In the “Business office name”, a business office name of a business office belonging to a company is recorded. In the “Location”, a location of this business office is recorded. In the “Contract serial number”, a contract serial number is recorded. The contract serial number is one of consecutive numbers that serves as identification information for uniquely identifying a contract document regarding the device 3 installed in this business office. The location is an example of information on the place where the device is installed.

FIG. 5 is a diagram illustrating an example of the device contract information table 713. The device contract information table 713 includes multiple items such as “Contract serial number”, “Model name”, “Machine number”, “Contract type”, and the like. Device contract information made up of these items is recorded by the control unit 70 at the time of conclusion of a contract or the like. The contract is a contract between a party who uses a device 3 and a party who manages the device 3. The contract serial number is assigned to the contract document, and the contract document includes a model name and a machine number, which are under contract. In the “Contract serial number”, as is the case with FIG. 4, a contract serial number is recorded as identification information that uniquely identifies a contract document. In the “Model name”, a name indicating the model of the device 3 is recorded. In the “Machine number”, a machine number that uniquely identifies the device 3 is recorded.

In the “Contract type”, a contract type indicating a type of contract such as a device contract, a logistic contract, a billing contract, or the like is recorded. The device contract is a lease contract, a maintenance contract, or the like. The maintenance contract is, for example, a yearly maintenance contract with a limited term of one year, a multiple year maintenance contract with a limited term of multiple years, a total maintenance contract regarding all components, a spot maintenance contract regarding specific components, or the like.

The device contract information table 713 is configured in such a way that a department (for example, administration department, legal department, or the like) that manages contracts of a company accesses the device contract information table 713 from a terminal that is not illustrated.

The business office information table 712 and the device contract information table 713 are linked to each other by using the contract serial number, and thus the contract is linked with the information on the place where the device 3 is installed. Furthermore, with the tables 711 to 713 of FIG. 3 to FIG. 5, respective pieces of the information are forming a tree structure. That is to say, with a manager at the top, the business office information is arranged at a layer below the top, and the device contract information is arranged at a layer below the business office information.

FIG. 6 is a diagram illustrating an example of the role master information table 714. The role master information table 714 includes multiple items such as “Role name”, “Function”, and the like. Role master information made up of these items is recorded by the control unit 70 at a time when a manager makes an addition, a change, or the like or at a time when a similar action is taken. The role master information table 714 is master information that defines one or more functions that can be used by each role. In the “Role name”, a role such as, for example, Billing, Audit, Maintenance, Facility, Accounting, or the like is recorded. In the “Function”, one or more functions included in the device 3 are recorded, and the one or more functions are associated with the role. For example, as illustrated in FIG. 6, in the case where the role name is Billing, a double-sided function, a color function, and a FAX function are associated with the role. In the case where the role name is Audit, the FAX function is associated with the role. In the case where the role name is Maintenance, a malfunction notification function and a toner notification function are associated with the role. In the case where the role name is Facility, a remote inspection function, a toner remaining amount function, and the like may be associated with the role. In the case where the role name is Accounting, a function for the total number of printed pages charged by pay-per-use, a function for the number of printed pages for each charge category, and a similar function may be associated with the role. In the case where the role name is Audit, an external communication history function such as FAX or the like and a similar function may be associated with the role. Note that in the “Function”, one or more functions that the manager manages are recorded, and the one or more functions recorded in the “Function” are not necessarily included in the device 3 managed by the manager.

FIG. 7 is a diagram illustrating an example of the machine master information table 715. The machine master information table 715 includes multiple items such as “Model name”, “Function”, and the like. Machine master information made up of these items is recorded by the control unit 70 at a time when the device 3 is added or changed or at a time when a similar thing happens. In the “Model name”, as is the case with FIG. 5, a name indicating the model of the device 3 is recorded. In the “Function”, as is the case with FIG. 6, one or more functions included in the device 3 are recorded, and the one or more functions are associated with the model.

FIG. 8 is a diagram illustrating an example of the machine information table 716. The machine information table 716 includes multiple items such as “Model name”, “Model number”, “Received date and time”, “Usage information”, and the like. Machine information made up of these items is recorded by the control unit 70 every time the usage information is sent from the device 3. In the “Model name”, as is the case with FIG. 5 and FIG. 7, a name indicating the model of the device 3 is recorded. In the “Machine number”, as is the case with FIG. 5, a machine number that uniquely identifies the device 3 is recorded. In the “Received date and time”, date and time when the usage information is sent from the device 3 is recorded. In the “Usage information”, usage information sent from the device 3 is recorded. The usage information is information associated with the function and, in particular, is the number of black-and-white copy pages of the day, the number of color copy pages of the day, the number of FAX pages of the day, the number of double-sided copy pages of the day, a toner remaining amount of the day, or the like. The machine information is an example of information regarding the past usage of the device.

Next, the control unit 70 is described.

The control unit 70 records the usage information in the device information table 716 when the usage information is sent from the device 3 together with the model name and the machine number thereof.

The control unit 70 receives authentication information of a manager and obtains information on a device managed by the manager and the role of the manager from the user information table 711, the business office information table 712, the device contract information table 713, and the like, which are linked with the authentication information of the manager.

The control unit 70 obtains the usage information of the device 3 managed by the manager from the tables 711 to 716 storing information regarding past usage of the device 3 in connection with the identification information of the device 3, extracts, of the obtained usage information, information on an item predetermined according to the role that the manager has, performs a tabulation process on the extracted information, and sends the tabulation result to the manager terminal 5. For example, the tabulation process is a process of summarizing usage information for each month and each function and arranging the total number of black-and-white copy pages, the total number of color copy pages, the number of FAX pages, or the like, or information on the past usage of each item such as a usage charge of black-and-white copy, color copy, FAX, or the like, into a summary table format, a summary diagram format, or the like. Note that the tabulation result may be formed as a csv file.

### Operation of Information Processing System

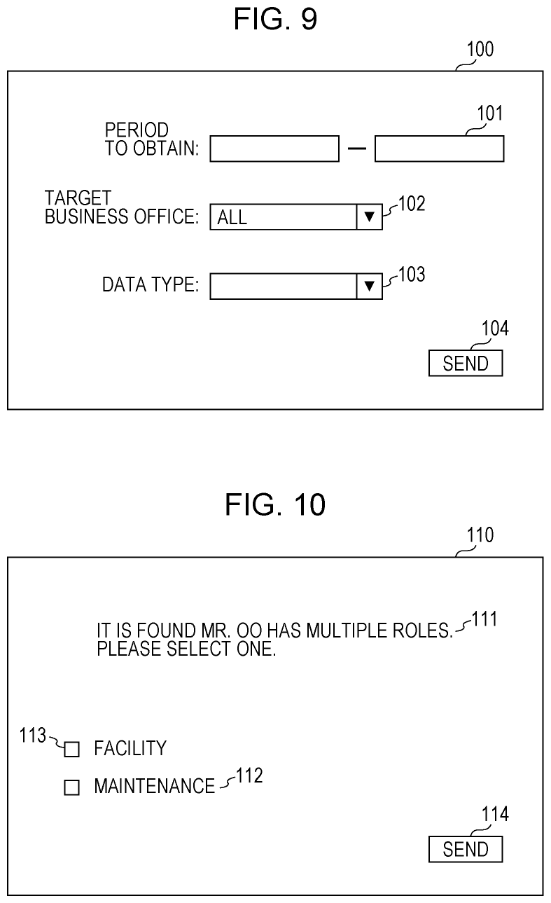

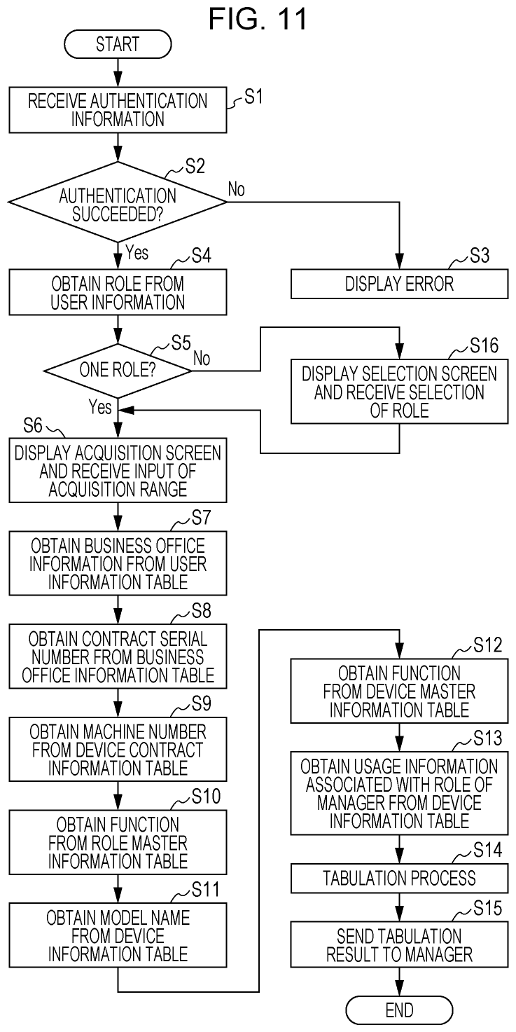

Next, an example of operation of the information processing system 1 is described with reference to FIG. 9 to FIG. 11. FIG. 11 is a flowchart illustrating an example of operation of the server 7. Note that unless otherwise specified, the operation is performed by the control unit 70 of the server 7.
(1) In the Case Where Requested by Facility Manager of the First Business Office 2A

The control unit 70 of the server 7 receives authentication information from the facility manager terminal 5A (S1). The authentication information includes a user ID and a password of the facility manager.

The control unit 70 determines whether or not authentication succeeds by checking whether or not the received authentication information is recorded in the user information table 711 (S2). When the authentication does not succeed (S2: No), the control unit 70 causes the facility manager terminal 5A to display an error (S3).

When the authentication succeeds (S2: Yes), one or more roles associated with the authentication information received in step S1 are obtained from the user information table 711 (S4). Here, it is assumed that Maintenance is obtained as the role.

The control unit 70 determines whether one role is obtained, or two or more roles are obtained (S5). When one role is obtained (S5: Yes), the control unit 70 causes the manager terminal 5 to display an acquisition screen and prompts input of information on an acquisition range (S6).

FIG. 9 is a diagram illustrating an example of the acquisition screen. An acquisition screen 100 includes an entry field 101 for a period to obtain to which a starting date (for example, 2019-11-01) and an ending date (for example, 2019-11-30) of the period to obtain are input, an entry field 102 for a target business office to which one or more target business offices (for example, all business offices or the like) are input by using a pull-down system, an entry field 103 for data type to which a data type of the usage information to obtain is input by using a pull-down system, and a “send” button 104 to send the input information as the information on an acquisition range to the server 7.

Of the business office information associated with the authentication information received in step S1, information on one or more target business offices input in step S6 is obtained from the user information table 711 (S7). Here, it is assumed that Sapporo branch is input as the target business office and the Sapporo branch is included in the business office information.

A contract serial number associated with the business office name obtained in step S7 is obtained from the business office information table 712 (S8). Here, it is assumed that 123456 is obtained as the contract serial number associated with the Sapporo branch.

A machine number associated with the contract serial number obtained in step S8 is obtained from the device contract information table 713 (S9). Here, it is assumed that 111111 is obtained as the machine number.

One or more functions associated with the role obtained in step S4 are obtained from the role master information table 714 (S10). Here, it is assumed that the malfunction notification function and the toner notification function are obtained as the functions associated with the role of Maintenance.

A model name associated with the machine number obtained in step S9 is obtained from the device information table 716 (S11). Here, it is assumed that Type A is obtained as the model name associated with the machine number of 111111.

One or more functions associated with the model name obtained in step S11 are obtained from the machine master information table 715 (S12). Here, it is assumed that as the one or more functions associated with the model name of Type A, the malfunction notification function, the toner notification function, the double-sided function, the color function, the scan function, and the FAX function are obtained. The device 3 of Type A has these functions.

With regard to one or more overlapping functions between the one or more functions associated with the role obtained in step S4 and the one or more functions associated with the model name obtained in step S11, usage information associated with the role of the manager is obtained from the device information table 716 while filtering with the information on an acquisition range input in step S6 (S13).

When the functions overlap, the following modes are possible:

(a) More functions are associated with the role than the function(s) included in the device;

(b) More functions are included in the device than the function(s) associated with the role; and

(c) The function(s) associated with the role agrees (agree) with the function(s) included in the device.

Here, the mode is the foregoing (b). Specifically, the functions associated with the role obtained in step S4 are the malfunction notification function and the toner notification function, and the functions associated with the model name obtained in step S11 are the malfunction notification function, the toner notification function, the double-sided function, the color function, the scan function, and the FAX function. Thus, the overlapping functions are the malfunction notification function and the toner notification function.

Next, the tabulation process that summarizes usage information of each item is carried out (S14). Here, since the functions associated with the role of the manager are the malfunction notification function and the toner notification function, the obtained usage information is arranged to form a summary table or a summary diagram of information on the past usage regarding the malfunction notification and the toner notification.

The tabulation result is sent to the facility manager terminal 5A (S15). From the tabulation result regarding the malfunction notification and the toner notification, the facility manager who manages the facility of the Sapporo branch of the first business office 2A may, for example, predict time of replacement of a component that has been often malfunctioned, predict time of replacement of toner from the toner remaining amount, and the like, for all the devices 3A, 3D, and 3E installed in the Sapporo branch.

In the foregoing step S5, when two or more roles are obtained (S5: No), the control unit 70 causes the manager terminal 5 to display a selection screen and prompts a selection of the role (S16).

FIG. 10 is a diagram illustrating an example of the selection screen. A selection screen 110 includes a message 111 saying “IT IS FOUND THAT MR. OO HAS MULTIPLE ROLES. PLEASE SELECT ONE.”, obtained roles 112, check boxes 113 for selecting the role 112, and a “send” button 114 for sending information on the selected role 112 to the server 7.

After the selection of the role, step S6 and succeeding steps are carried out as with the above, and thus the descriptions thereof are omitted.
(2) In the Case Where Requested by Another Manager

In the case where requested by the facility manager of the second business office 2B, as is the case where requested by the facility manager of the first business office 2A, of the usage information of all the devices 3B and 3D installed in the second business office 2B, the items associated with the role of this facility manager are tabulated, and the tabulation result is sent to the facility manager terminal 5B (S15).

In the case where requested by the general manager, as is the case where requested by the facility manager of the first business office 2A and the case where requested by the facility manager of the second business office 2B, of the usage information of all the devices 3 installed in all the business offices 2A and 2B, the items associated with the role of the general manager are tabulated, and the tabulation result is sent to the general manager terminal 5C (S15).

In the case where requested by the security manager, of the usage information of the devices 3D having the FAX function installed on the 11th floor of the first business office 2A and on the 3rd floor of the second business office 2B, the items associated with the role of the security manager, for example items associated with the audit, are tabulated, and as the tabulation result, information on FAX communication records is sent to the security manager terminal 5D (S15).

In the case where requested by the accounting manager of the organization X, of the usage information of the devices 3E belonging to the organization X, the items associated with the role of the accounting manager, for example items associated with the accounting, are tabulated, and as the tabulation result, information regarding the pay-per-use charge is sent to the accounting manager terminal 5E (S15).

### MODIFIED EXAMPLE 1

When multiple roles are obtained for the manager, at the time of sending information to the manager terminal 5, the control unit 70 may merge information in such a way that information on an item predetermined according to the role does not overlap and send the merged information. According to this modified example 1, the manager may receive easy-to-view documents rather than overlapping documents.

The exemplary embodiment of the present disclosure has been described in the foregoing section. However, an exemplary embodiment of the present disclosure is not limited to the foregoing exemplary embodiment, and various modifications and implementations may be made.

Each part of the processor may be composed wholly or partially of a hardware circuit such as a field programmable gate array (FPGA), an application specific integrated circuit (ASIC), or the like.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above and may be changed.

Part of constituent elements of the foregoing exemplary embodiment may be omitted or changed. In the flow of the foregoing exemplary embodiment, a step may be added, deleted, modified, replaced, or the like. The program used in the foregoing exemplary embodiment may be provided by recording the program on a computer-readable recording medium such as a CD-ROM or the like or may be stored in an external server such as a cloud server or the like and used via a network.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
obtain information regarding past usage of a device managed by a manager from stored information, the stored information storing information regarding the past usage of a device in connection with identification information of the device,
extract, of obtained information regarding the past usage, information on an item predetermined according to a role that the manager has, and
send extracted information to a terminal of the manager.

2. The information processing apparatus according to claim 1, wherein the processor is configured to receive identification information of the manager and obtain information on a device managed by the manager from information regarding the manager linked with the identification information of the manager.

3. The information processing apparatus according to claim 2, wherein the information regarding the manager includes information on a place where the device managed by the manager is installed.

4. The information processing apparatus according to claim 1, wherein the processor is configured to receive identification information of the manager and obtain a role of the manager from information regarding the manager linked with the identification information of the manager.

5. The information processing apparatus according to claim 2, wherein the processor is configured to receive the identification information of the manager and obtain a role of the manager from the information regarding the manager linked with the identification information of the manager.

6. The information processing apparatus according to claim 3, wherein the processor is configured to receive the identification information of the manager and obtain a role of the manager from the information regarding the manager linked with the identification information of the manager.

7. The information processing apparatus according to claim 4, wherein when a plurality of roles is obtained for the manager, the processor is configured to cause a display of a selection screen and prompt a selection from among the plurality of roles.

8. The information processing apparatus according to claim 5, wherein when a plurality of roles is obtained for the manager, the processor is configured to cause a display of a selection screen and prompt a selection from among the plurality of roles.

9. The information processing apparatus according to claim 6, wherein when a plurality of roles is obtained for the manager, the processor is configured to cause a display of a selection screen and prompt a selection from among the plurality of roles.

10. The information processing apparatus according to claim 4, wherein when a plurality of roles is obtained for the manager, the processor is configured to, at time of sending information to the terminal of the manager, merge information in such a way that information on an item predetermined according to the role does not overlap and send merged information.

11. The information processing apparatus according to claim 5, wherein when a plurality of roles is obtained for the manager, the processor is configured to, at time of sending information to the terminal of the manager, merge information in such a way that information on an item predetermined according to the role does not overlap and send merged information.

12. The information processing apparatus according to claim 6, wherein when a plurality of roles is obtained for the manager, the processor is configured to, at time of sending information to the terminal of the manager, merge information in such a way that information on an item predetermined according to the role does not overlap and send merged information.

13. The information processing apparatus according to claim 1, wherein the item is also associated with a contract regarding the device.

14. The information processing apparatus according to claim 2, wherein the item is also associated with a contract regarding the device.

15. The information processing apparatus according to claim 3, wherein the item is also associated with a contract regarding the device.

16. The information processing apparatus according to claim 4, wherein the item is also associated with a contract regarding the device.

17. The information processing apparatus according to claim 13, wherein information on the contract is linked with information on a place where the device is installed.

18. The information processing apparatus according to claim 1, wherein the item relates to an overlapping function between a function assigned to the role and a function included in a device managed by the manager.

19. The information processing apparatus according to claim 18, wherein the processor is configured to extract information on the item within a preset acquisition range at time of extracting the information on the item.

20. A non-transitory computer readable medium storing a program causing a computer to execute a process, the process comprising:
obtaining information regarding past usage of a device managed by a manager from stored information, the stored information storing information regarding the past usage of a device in connection with identification information of the device;
extracting, of obtained information regarding the past usage, information on an item predetermined according to a role that the manager has; and
sending extracted information to a terminal of the manager.
